(19) United States
(12) Patent Application Publication
(10) Pub. No.: US 2007/0152643 A1
(43) Pub. Date: Jul. 5, 2007

(54) Apparatus and method for resistively controlling airflow to circuit packs

(76) Inventor: Thomas Francis Craft JR., Hackettstown, NJ (US)

Correspondence Address: MCCORMICK, PAULDING & HUBER LLP, 185 ASYLUM STREET, CITY PLACE II, HARTFORD, CT, 06103, US

(21) Appl. No.: 11/323,263

(22) Filed: Dec. 30, 2005

(51) Int. Cl. G05F 3/00

(52) U.S. Cl. 323/212

(57) ABSTRACT

Airflow through a plurality of circuit packs is optimized by resistively limiting airflow to circuit packs determined to experience excess airflow, typically those circuit packs with lower heat-dissipating component density. Excess airflow is preferably reduced by a backpressure generation means, such as an airflow resistor connected to the circuit pack. The airflow resistor defines a clearance area sized to achieve the desired airflow reduction.

### FIELD OF THE INVENTION

The present invention relates to circuit packs and, more particularly, to multiple air-cooled circuit packs installed in a receptacle, such as an electronics cabinet, workstation, or the like.

### BACKGROUND OF THE INVENTION

Circuit packs containing multiple electronic components have become extremely important to the electronics infrastructure of a wide range of industries, businesses, government entities, and other users of electronics. It is well known to arrange electronic circuitry, usually for accomplishing one or more functions (e.g. telecom, video processing) on a single card with purpose-appropriate inputs and/or outputs. The card (or circuit pack) is then installed in a slot or receptacle located in an electronics cabinet, workstation, or the like. The slot is sized to accommodate a standard-sized circuit pack, typically such that the inputs and/or outputs on the circuit pack engage with appropriate connections, allowing the circuit pack functionality to be available within a larger electronics system.

The use of circuit packs is beneficial for a number of reasons. Adding and upgrading the capabilities of the system can be done by adding additional circuit packs or replacing existing circuit packs with newer models. System down time for repairs is minimized because faults can readily be isolated to a circuit pack, allowing for easy replacement of the faulty circuit pack with minimal impact to the rest of the system.

The electronic components,on each circuit pack generate heat as a result of power dissipation. Unless a cooling means is supplied, excess heat can build up, leading to improper functioning and premature failure of circuit pack components. Typically, an electronics cabinet, workstation, or the like includes with one or more fans to facilitate cooling by forcing air through the circuit packs. However, with increasing miniaturization and increasing demands on the capabilities of individual circuit packs, the trend is toward an ever-increasing density of electronics components on circuit packs. Heat generation on these densely populated circuit packs is often very near the heat removal capacity of the conventional forced air methods.

Aggravating the problem is the fact that in cabinets, workstations, or the like with multiple circuit packs, airflow is greatest where the circuit pack density is lowest. This phenomenon occurs because resistance to airflow is typically lower in circuit packs with fewer electronic components and greater in densely populated circuit packs. Consequently, the most cooling air is being supplied to the circuit packs that generate the least heat, such that the circuit packs with higher heat generation have a greater probability of excessive heat build-up.

Attempts have been made to provide more cooling to these densely populated circuit packs first by using higher performance fans, and also by using liquid cooling and/or cold plates, but such cooling methods are typically expensive and complex, increase the time and skill required to replace circuit packs, and are often not adaptable for use with existing electronics cabinets, workstations, or the like. Accordingly, it can be seen that there is a need for an inexpensive method for optimizing the cooling of high density circuit packs, that preserves all the ease and convenience of readily interchangeable circuit packs, and allows the continued use of existing electronic cabinets, workstations, or the like.

### SUMMARY OF THE INVENTION

According to an embodiment of the present invention, an electronics system includes an airflow generation means and a plurality of circuit packs installed in a receptacle, at least one of the circuit packs having a backpressure generation means, wherein the backpressure generation means is effective for increasing airflow to at least another of the circuit packs.

According to a further embodiment of the present invention, a circuit pack adaptable for installation in a circuit pack receptacle includes a circuit board, and a backpressure generation means associated with the circuit board.

According to an additional embodiment of the present invention, an airflow resistor has a resistor body adapted to reduce excess airflow when used in connection with a circuit pack.

In operation, it is determined if excess airflow is supplied to one of the circuit packs, and the airflow is then restricted to one of the circuit pack based on the determination, wherein airflow to another of the circuit packs in increased.

These and other features and advantages of the present invention will be better understood from the drawings and in light of the detailed description, below.

### BRIEF DESCRIPTION OF THE DRAWINGS

FIG. 1 is a front view of a circuit pack receptacle, accommodating a plurality of circuit packs having backpressure generation means, according to an embodiment of the present invention;

FIG. 2 is a rear view of the circuit pack receptacle of FIG. 1;

FIG. 3 is a circuit pack having a backpressure generation means, and adapted for accommodation in the receptacle of FIG. 1;

FIG. 4 is flowchart illustrating an operation for optimizing airflow through a plurality of circuit packs, according to another embodiment of the present invention;

FIGS. 5 is a front view of a circuit pack having a backpressure generation means, according to a further embodiment of the present invention;

FIG. 6 is a front view of a circuit pack having a backpressure generation means, according to an additional embodiment of the present invention;

FIG. 7 is a front view of a circuit pack having a backpressure generation means, according to another embodiment of the present invention;

FIG. 8 is a front view of a circuit pack having a backpressure generation means, according to a further embodiment of the present invention; and

FIG. 9 is a perspective view of a circuit pack having a backpressure generation means, according to an additional embodiment of the present invention.

### DETAILED DESCRIPTION

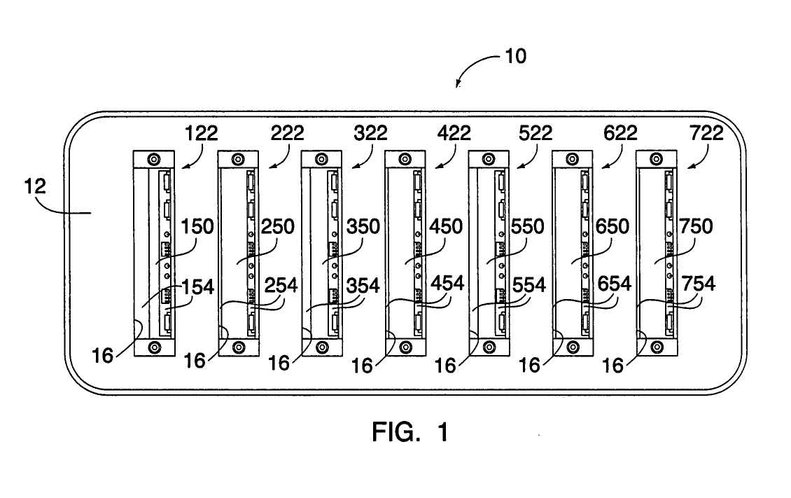

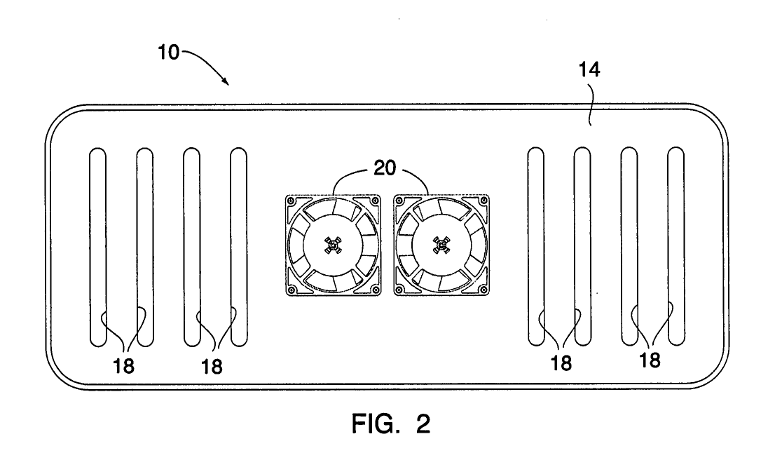

Referring to FIGS. 1 and 2, a receptacle 10 includes a first face 12 and a second face 14. The receptacle 10 can be an electronics cabinet, workstation, or the like. A plurality of slots 16 are disposed in the first face 12. A plurality of ventilation openings 18 and an airflow generation means 20, for inducing airflow through the receptacle 10, are disposed in the second face 14. In the depicted embodiment, fans 20 serve as the airflow generation means. The fans 20 are installed such that air is drawn into the receptacle 10 through the slots 16 and exhausted through the fans 20.

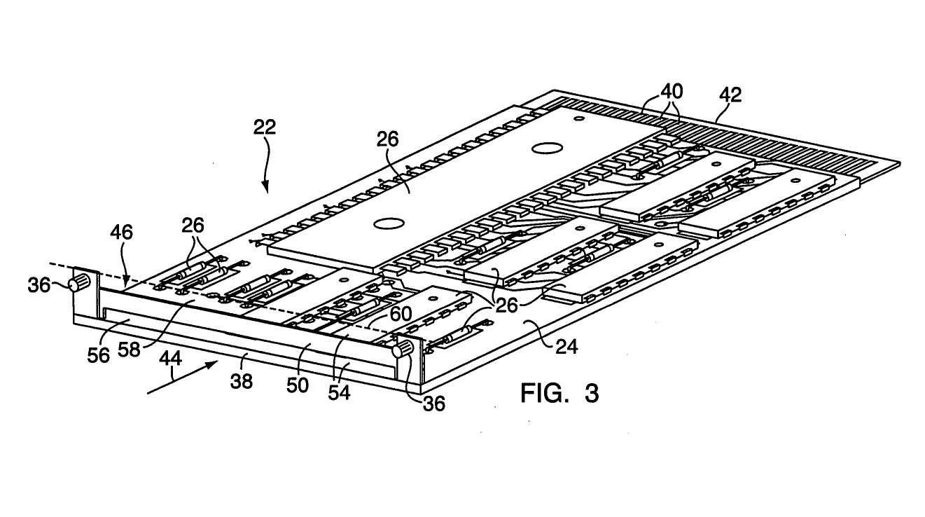

Referring to FIG. 3, a circuit pack 22 is adapted for accommodation within any of the slots 16 in the receptacle 10. Circuit pack 22 is fabricated from a circuit board 24, on which a plurality of electronics components 26 are mounted. Securing means 36, such as thumb screws, or the like, are disposed on a circuit pack airflow entrance end 38. A plurality of connectors 40 are disposed on a circuit pack airflow exit end 42. When the circuit pack 22 is accommodated within the slot 16 of the receptacle 10, airflow induced by the airflow generation means 20 enters the circuit pack from the airflow entrance end 38 in the direction of the arrow 44, passes around components 26 on circuit board 24 and exits receptacle 10 through ventilation openings 18.

A backpressure generation means 46 is disposed on the airflow entrance end 38. In the depicted embodiment, the backpressure generation means is an airflow resistor 46 formed with a resistor body 50. Resistor body 50 at least partially defines a clearance area 54. In the depicted embodiment, clearance area 54 is discontinuous and includes a first partial clearance area 56, which is further defined by the airflow entrance end 38, and a second partial clearance area 58, which is further defined by a reference line 60. The airflow resistor 46 generates backpressure as airflow entering the circuit pack 22 from the direction of arrow 44 is impeded by resistor body 50. The backpressure thus generated resists the free flow of air through the circuit pack 22 and only some reduced airflow is able to enter through the clearance area 54. The smaller the clearance area defined by the resistor body, the greater the generated backpressure. In other words, generally speaking, the larger the overall area of the resistor body 50, the greater the backpressure generated.

Referring again to FIG. 1, a plurality of circuit packs 122-722 are accommodated within the plurality of slots 16. In the embodiment shown, circuit pack 122 experiences high heat generation, circuit packs 322 and 522 experience moderate heat generation, and circuit packs 222, 422, 622 and 722 experience low heat generation. To reduce excess airflow (airflow in excess of the airflow required to supply adequate cooling based on the heat generation of the circuit pack) through the low heat generation circuit packs 222, 422, 622 and 722, the corresponding resistor bodies 250, 450, 650 and 750 define relatively small clearance areas 254, 454, 654, and 754. This reduction of excess airflow through the low heat generation circuit packs 222, 422, 622 and 722 is effective for increasing airflow to the remaining, higher heat generation circuit packs 122, 322 and 522, relative to an airflow supplied to higher heat generation circuit packs in an identical receptacle without the backpressure generation means of the present invention. A portion of this increased airflow is supplied to circuit packs 322 and 522 due to the larger clearance areas 354 and 554 defined by the corresponding resistor bodies 350 and 550. The largest portion of the increased airflow in receptacle 10 is experienced by the circuit pack 122, as resistor body 150 defines the largest clearance area 154.

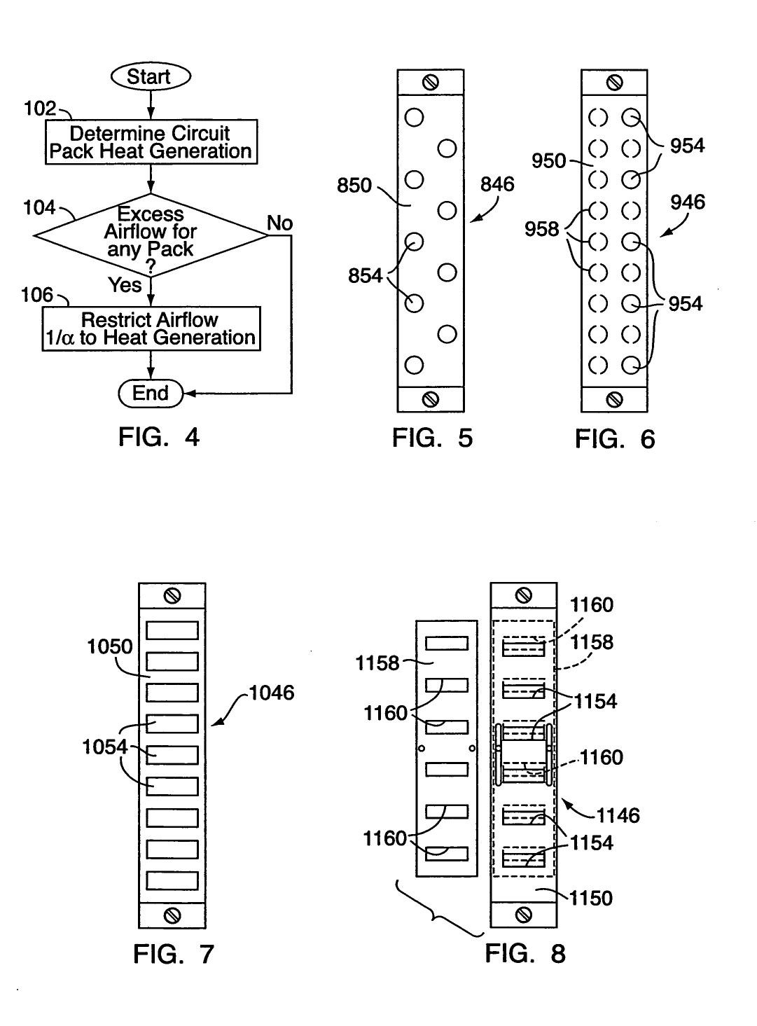

Referring to FIG. 4, in operation, for optimizing airflow through a plurality of circuit packs in a receptacle, the heat generation of each of the circuit packs is determined (102). The heat generation determination in this embodiment is made analytically, using, for example, a computational fluid dynamics program, or experimentally, using, for example, an infrared pyrometer to measure the temperature of each circuit pack during operation, or with a combination of analytical and experimental techniques. Once the heat generation determination (102) has been made, a determination is made if excess airflow exists for any circuit pack (104). Airflow for each circuit pack is then selectively restricted (106), preferably in inverse proportion (1/α) with heat generation, by providing a backpressure generation means, such as an airflow resistor, for each circuit pack to achieve the appropriate reduction in excess airflow.

From the foregoing it can be seen that the novel apparatus of the present invention allows the optimization of airflow through a plurality of circuit packs such that the circuit packs with the highest heat generation experience the highest airflow. The tendency of higher heat generating circuit packs to experience relatively low airflow because of the typically greater density of electronic components in such circuit packs is alleviated by resistively controlling airflow to lower heat generation circuit packs using airflow resistors with smaller clearances, which generate greater backpressure. Airflow resistors with larger clearances, which generate lower backpressure, are included on higher heat generation circuit packs. Because no additional liquid cooling or additional structures, such as cold plates, are necessary, the present invention results in little, if any, additional expense, and maintains the easy interchangeability of circuit pack configurations. Furthermore, the usefulness of existing cooling fans, and electronics cabinets, workstations, and the like is extended.

It will be dear to those skilled in the art that the present invention is not limited to the described embodiments, but that numerous variations and modifications can be made within the scope of the present invention.

For instance, the present invention is not limited to a particular circuit pack receptacle, but any of the several well-known circuit pack receptacles may be used. Such receptacles include, but are not limited to: workstations, electronics cabinets, and equipment racks. Accordingly, the term “receptacle” is used generically, and does not itself imply a specific structure beyond the capacity to receive multiple circuit packs.

Additionally, the fans 20, depicted in FIG. 2, are just one example of an airflow generation means. It will be dear to those skilled in the art that various numbers and/or designs of fans, as well as other means for inducing airflow, may be used without departing from the scope of the present invention.

Various backpressure generation means 46 may also be employed, and various designs and placements of airflow resistors are possible and fall within the scope of the present invention. The airflow resistors depicted in FIGS. 1 and 3 are only one of many possible designs. Generally, the airflow resistors should be designed such that the total clearance is appropriate for the heat generation of an airflow resistor's associated circuit pack. Although other considerations may dictate the general shape of an airflow resistor (e.g. a need for indicator/status lights and/or test terminals), a broad range of airflow resistor designs can be employed consistently with optimizing airflow according to the present invention.

FIGS. 5-8 show various other embodiments of circuit packs having airflow resistors according to the present invention, though these Figures by no means depict all possible designs. In FIGS. 5 and 6, airflow resistors 846 and 946 are shown with resistor bodies 850 and 950 defining a clearance area in the form of discrete holes 854 and 954. A larger clearance area may be formed by increasing the number or size of holes. Additionally, airflow resistor 946 further includes a plurality of partially punched holes 958. Airflow is not possible through a partially punched hole 958 until the hole center is completely removed, as in holes 954. Such an embodiment allows for adjustment of the clearance area 954 after the airflow resistor 946 is connected to a circuit pack or installed in a receptacle.

In FIGS. 7 and 8, airflow resistors 1046, 1146 include resistor bodies 1050 and 1150, which define a clearance area in the form a plurality of slits 1054 and 1154, respectively. A sliding plate 1158 (shown exploded and in broken lines) with matching slits 1160 can also be mounted to correspond to the slits 1154 such that the dearance area can be repeatedly adjusted after the airflow resistor 1146 is connected to a circuit pack or installed in a receptacle.

It is not necessary that the backpressure generation means be located at the airflow entrance end of the circuit pack, as in FIGS. 1 and 3. While such a location results in a relatively uniform reduction of airflow across the entire circuit pack, the airflow resistor can also be located at some other position on the circuit pack. Multiple and/or segmented airflow resistors can also be located at various points on a given circuit pack to further optimize airflow to particular circuit pack components, and can also be used in combination with a “master” resistor on the airflow entrance end of the circuit pack.

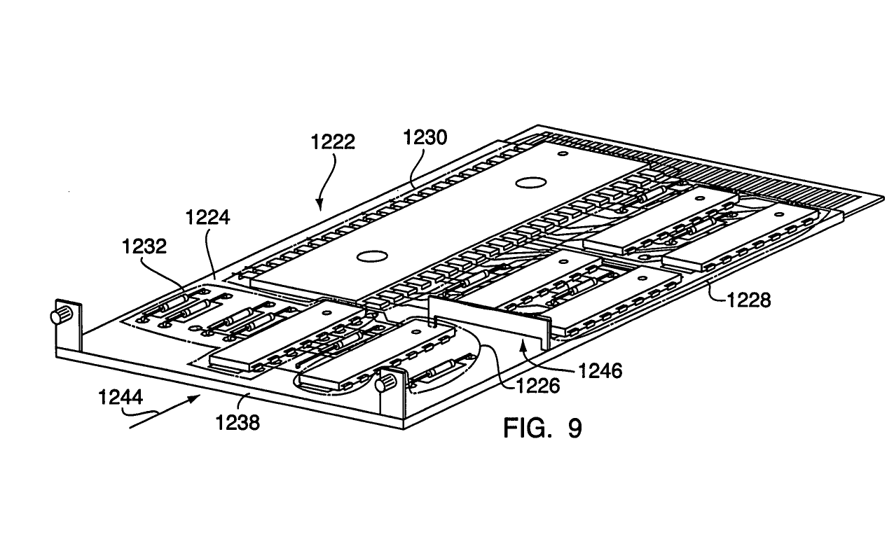

Circuit pack 1222, referring to FIG. 9, has component groupings 1226-1232 mounted on circuit board 1224. Grouping 1228 generates relatively little heat, grouping 1226 experiences intermediate heat generation, and groupings 1230 and 1232 experience higher heat generation. Airflow enters the circuit pack 1999 at airflow entrance end 1238 from the direction of arrow 1244. An airflow resistor 1246 is placed downstream of the airflow entrance end 1238, but upstream of grouping 1228, thus generating backpressure which reduces excess airflow to grouping 1228 while ensuring that groupings 1230 and 1232 receive a greater proportion of the airflow across the circuit pack 1222. Depending on the precise relative locations of grouping 1226 and airflow resistor 1246, grouping 1226 may experience lower airflow than groupings 1230 and 1232, but more airflow that grouping 1228.

Furthermore, various means may be employed to determine the heat generation of the circuit packs. The heat generation may be determined based on past knowledge or modeling based on factors such as component type and density. If heat generation is empirically determined, various other well-known methods of heat measurement may also be employed.

While resistively controlling airflow in inverse proportion to heat generation may tend to produce a more optimized airflow, a strict mathematical relationship need not be applied. In general, it is desirable to resistively limit airflow to lower heat generation circuit packs enough such that higher heat generation circuit packs receive a sufficient percentage of the overall available airflow to provide sufficient cooling, while still ensuring that the reduced airflow provided to the lower heat generation circuit packs remains sufficient. “Excess airflow,” as used herein, refers to airflow supplied to a circuit pack in excess of the airflow required to adequately cool the circuit pack.

Though the foregoing are some examples of variations of the described embodiment that fall within the scope of the present invention, it will be appreciated by those skilled in the art that numerous other variations and modifications are possible without departing from the scope of the present invention.

I claim:

1. An electronics system comprising:
a plurality of circuit packs accommodated in a receptacle, at least one of said circuit packs including a backpressure generation means; and
an airflow generation means for generating airflow through said receptade;
wherein said backpressure generation means is effective for increasing airflow to at least another of said circuit packs.

2. The electronics system of claim 1, wherein said backpressure generation means includes an airflow resistor connected to said circuit pack and defining a clearance area, said clearance area sized to reduce excess airflow to said at least one of said circuit packs.

3. The electronics system of claim 2, wherein said clearance area is adjustable after being connected to said at least one circuit pack.

4. The electronics system of claim 1, wherein each of said plurality of circuit packs includes a backpressure generation means.

5. The electronics system according to claim 4, wherein each said backpressure generation means includes an airflow resistor defining a clearance area, each of said clearance areas variously sized to reduce excess airflow to each of said plurality of circuit packs.

6. A circuit pack adaptable for accommodation in a circuit pack receptacle, the circuit pack comprising:
a circuit board; and
a backpressure generation means associated with said circuit board.

7. The circuit pack of claim 6, wherein said backpressure generation means includes an airflow resistor at least partially defining a clearance area and connected to said circuit board, said clearance area being sized to reduce excess airflow to said circuit pack when said circuit pack is accommodated in a circuit pack receptacle.

8. The circuit pack of claim 7, wherein said clearance area is adjustable.

9. The circuit pack of claim 7, wherein said airflow resistor is attached to an airflow entrance end of said circuit pack.

10. The circuit pack of claim 7, wherein said circuit board has at least two electronics components attached thereto and said airflow resistor is positioned on said circuit board so as to result in a greater reduction of excess airflow to one of said at least two electronics components having a lower heat generation.

11. An airflow resistor comprising:
a resistor body adapted to reduce excess airflow when used in connection with a circuit pack.

12. The airflow resistor of claim 11, wherein said resistor body at least partially defines a clearance area, said clearance area being sized to reduce excess airflow to a circuit pack.

13. The airflow resistor of claim 12, wherein said clearance area is adjustable.

14. The airflow resistor of claim 12, wherein said clearance area is formed as discrete holes in said resistor body.

15. The airflow resistor of claim 12, wherein said clearance area is formed as slits in said resistor body.

16. The airflow resistor of claim 12, wherein said resistor body is adapted for connection with an air entrance end of a circuit pack.

17. The airflow resistor of claim 12, wherein said resistor body is adapted for connection with a location downstream of an air entrance end of a circuit pack.

18. The airflow resistor of claim 12, wherein said clearance area is adjustable after said resistor body is connected to a circuit pack.

19. The airflow resistor of claim 18, wherein said clearance area is adjustable after installation of a circuit pack into a receptacle.

20. The airflow resistor of claim 12, wherein said clearance area is repeatedly adjustable.
